(19) United States
(12) Patent Application Publication
(10) Pub. No.: US 2011/0174444 A1
(43) Pub. Date: Jul. 21, 2011

(54) Nozzle including a Jointed Application Pallet

(75) Inventors: Jean-Claude Delorme, Mirefleurs (FR); Christophe Ougier, Le Crest (FR)

(73) Assignees: SOCIETE DE TECHNOLOGIE MICHELIN, Clermont-Ferrand (FR); Michelin Rechererche et Technique S.A., Granges-Paccot (CH)

(21) Appl. No.: 12/936,339

(22) PCT Filed: Mar. 30, 2009
(86) PCT No.: PCT/EP09/53718

§ 371 Date: Mar. 24, 2011

(30) Foreign Application Priority Data
Apr. 2, 2008 (FR) 0852163

(51) Int. Cl. B32B 37/00

(52) U.S. Cl. 156/583.1; 156/580

(57) ABSTRACT

Device (1) for applying a strip (B) of a viscoelastic material to a receiving surface (S) in relative motion (R) with respect to the device, comprising a feed means and an application nozzle (1) at the end of which there is an outlet orifice (10). The outlet orifice comprises a front lip (11) and a rear lip (12). The rear lip (12) is connected to an applicator flap (2) by an elastic articulated joint (3) so that the applicator flap (2) applies pressure pressing the strip (B) onto the surface (S) when the device (1) is functioning.

The invention relates to the field of the manufacture of products based on viscoelastic materials such as plastics or elastomers.

More specifically, the invention involves the field of the laying of profiles in the form of strips superimposed on one another at a pitch and with a degree of overlap that have been determined according to the final profile that is to be obtained.

Typically, this well known type of laying is employed in the manufacture of a green tire, during which manufacture a strip of a product of rubbery nature is wound around a receiving surface of cylindrical or toroidal shape, and with a very well defined pitch, so as to form, through the superposition of layers of strips of the same quality, a rubber profile of given quality and arranged precisely according to the position occupied by this profile in the tire.

The known devices and means of assembly as a general rule comprise three types of means operating in collaboration with one another:
a receiving surface,
a feed means for generating a strip with a defined geometry,
a means of applying the strip to a receiving surface, and
a means for controlling the movements of the application means in relation to the receiving surface.

By way of example, the devices described in publication EP 268 544 or alternatively in publication EP 264 600 describe all of the means mentioned hereinabove.

Devices of this type make it possible to dispense with the steps of manufacturing the said profiles, which steps are generally performed from centralized manufacturing facilities. Specifically, the strip is produced to order at the time of assembly. For a given strip profile, the definitive profile laid on the receiving surface is dependent only on the algorithm used to control the application means and on the cross section of the strip. Hence, the flexibility with which these methods can be used is the reason why these methods are so widely used.

Use of this type of method essentially relies on the quality of the means that generates the strip because it is important that the cross section of the strip be as close as possible to the desired reference cross section so that the amount of material laid corresponds precisely to the expected amount.

For this reason rubber profile generating means capable of providing a rigorously constant output have been developed. This type of means is described by way of example in publication EP 0 400 496 A1 in the name of the applicant.

Further, the shape of the profile has to be chosen carefully to allow the layers of strip to be sealed as perfectly as possible to one another with a view, as far as possible, to avoiding the inclusion of air between the layers of strip as such air would be detrimental to the strength of the tire in service.

Also, it has been proposed for strips of substantially lenticular cross section to be produced, this being with a view to avoiding edge effects.

Finally, for optimum strip laying quality, and to make it easier to apply and seal the strip to the receiving surface, it is important for the application means to be positioned as close as possible to the receiving surface.

The known devices have means that allow the assembly made up of the feed means which are secured to the application means to be brought closer to the receiving surface. The mass of this assembly of means is relatively high. This means that it is difficult to achieve fine and precise control over the position of the application means in relation to the receiving surface so that the application means can follow all the unevennesses of the receiving surface. Also, as is known, it has been proposed for an application roller to be positioned downstream of the application means to improve the sealing of the strip to the receiving surface. A device of this kind is divulged by way of example in the publication EP 264 600 already mentioned hereinabove. This application roller applies controlled pressure to the point at which the strip comes into contact with the receiving surface.

However, it is found that this roller, which, as a general rule, is carried on the application means, represents a source of problems; the strip sometimes sticks to the surface of the roller, or else it escapes via the gap between the outlet orifice of the nozzle and the application roller, and these anomalies lead to breaks in the laying cycle, and to deformation or even breakage of the strip.

It is an object of the invention to overcome these disadvantages.

According to the invention, the device for applying a strip of a viscoelastic material to a receiving surface in relative motion with respect to the said device comprises a feed means and an application nozzle at the end of which there is an outlet orifice, the said outlet orifice comprising a front lip and a rear lip.

The device according to the invention is characterized in that the rear lip is connected to an applicator flap by an elastic articulated joint, so that, when the device is functioning, the said flap applies pressure to the back of the strip with a view to causing the latter to adhere to the receiving surface.

Thus, there is no gap between the rear lip of the nozzle and the application device. The tension of the elastic articulated joint allows an application force to be applied to the strip, and thus encourages it to adhere to the receiving surface.

In addition, the applicator flap, because of its very low weight, is able to absorb all the unevennesses of the receiving surface while at the same time applying constant pressure. In this way, the disadvantages associated with the combined mass of the feed means and of the nozzle are eliminated.

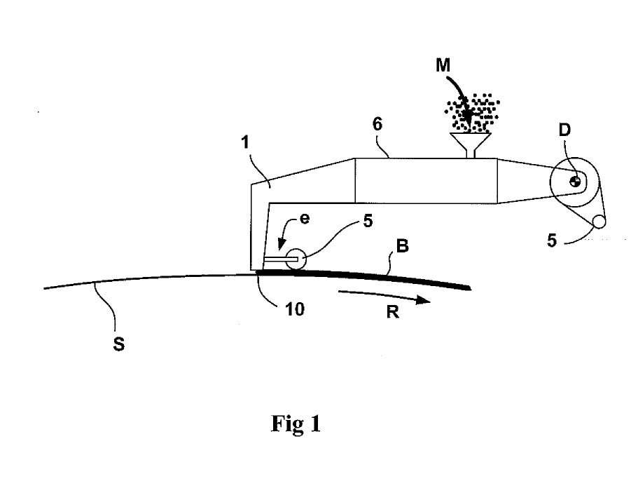

The description which follows relies on one embodiment of the invention and on FIGS. 1 to 3 in which:

FIG. 1 depicts a schematic view of a device according to the known prior art,

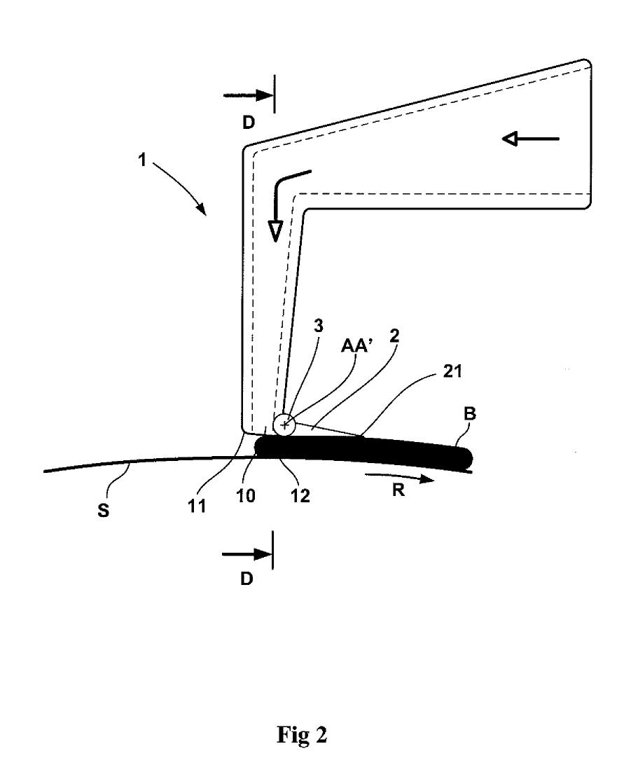

FIG. 2 depicts a schematic view of an application nozzle according to the invention, and

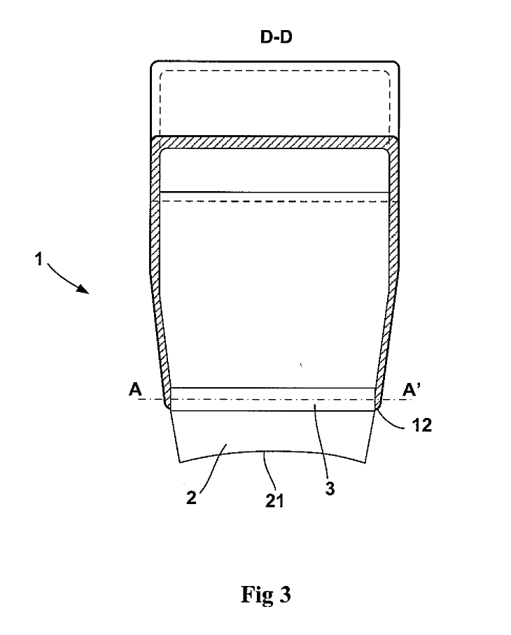

FIG. 3 depicts a schematic view in cross section on D-D of a nozzle according to the invention.

The device according to the known prior art depicted schematically in FIG. 1 comprises a feed means 6, into which the viscoelastic material M is introduced to feed it to a nozzle 1 at a given feed rate and pressure. The receiving surface S is in motion in relation to the application device in a direction R. The mixture deposited on the receiving surface forms a strip B. An applicator roller 5 may be positioned downstream of the material outlet orifice 10. In this device, the assembly formed by the nozzle and the feed means 6 form a unit assembly able to move about an axis C under the action of a motorized means 5.

Notice the gap e between the roller and the outlet of the nozzle via which gap the strip is liable to escape when the strip has not yet finished adhering to the receiving surface.

The application device depicted in FIG. 2, which depicts only the application nozzle, is connected to a feed means 6 the outlet duct of which opens into the nozzle 1 in an entirely similar way to the setup illustrated in FIG. 1 and described in the paragraphs above.

The direction in which the viscoelastic material travels inside the nozzle 1 is identified by the open-headed arrows.

The nozzle orifice 10 comprises a front lip 11 and a rear lip 12. An applicator flap 2 is connected by an articulated joint 3 to the rear lip of the nozzle. The axis of the articulated joint AA′ is substantially parallel to the receiving surface S and perpendicular to the direction R of travel of the receiving surface S in relation to the nozzle 1.

The said articulated joint comprises an elastic element able to apply a return moment to the applicator flap so that the flap 2 applies an application pressure to the back of the strip B when the device is functioning.

The elastic element may be formed of a spring or of any other means able to apply the said return moment. In practice, the application force is relatively modest, and falls within a range of the order of 100 to 500 N, when the material used is rubber.

The applicator flap can be produced in such a way as to form a rigid element or, for preference, may be made using a flexible material so as to give it a certain degree of flexibility when the applicator flap is applying pressure to the back of the strip.

FIG. 3 depicts a cross section on DD of the applicator nozzle. It is possible to see the rear lip 12 to which the elastic articulated joint 3 supporting the applicator flap 2 is fixed.

The rear edge 21 of the applicator flap may beneficially have a substantially concave shape when the said flap is viewed in projection on a plane perpendicular to the direction R, so that the applicator flap gives the strip a lenticular shape.

It is also possible to provide heating means on the applicator flap. Indeed it may prove beneficial to heat the said flap to encourage the strip smoothing effect. By way of indication, the temperature of the applicator flap 2 will be set so that its value is higher than the material outlet temperature.

The setup of the preferred embodiment of the invention described hereinabove is put forward here by way of example and is typified by its compactness, its lightness of weight and its ease of assembly, which allows very good following of the unevennesses of the receiving surface.

The device described hereinabove is particularly well suited to producing green tires by stacking strips. Consequently, the elastomeric material will preferably be of a rubbery nature. The receiving surface will consist of a green tire in the process of being built and the shape of which is generally cylindrical or toroidal.

1. A device for applying a strip of a viscoelastic material to a receiving surface in relative motion with respect to the device, comprising a feed means and an application nozzle at the end of which there is an outlet orifice, the outlet orifice comprising a front lip and a rear lip,
wherein the rear lip is connected to an applicator flap by an elastic articulated joint of axis AA′, so that, when the device is functioning, said flap applies pressure to the back of the strip with a view to causing the latter to adhere to the receiving surface.

2. The device according to claim 1, wherein the axis AA′ of the elastic articulated joint is substantially parallel to the receiving surface and perpendicular to the direction of the relative motion.

3. The device according to claim 1, wherein a rear edge of the applicator flap is of concave shape.

4. The device according to claim 1, wherein said applicator flap is formed using a flexible material.

5. The device according to claim 2, wherein the applicator flap comprises heating means connected to a temperature regulating means.
